(19) United States
(12) Patent Application Publication
(10) Pub. No.: US 2005/0049978 A1
(43) Pub. Date: Mar. 3, 2005

(54) Method for secure transaction of payments via a data network

(76) Inventor: Martin Kleen, Neunkirchen (DE)

Correspondence Address: SCHIFF HARDIN, LLP;PATENT DEPARTMENT, 6600 SEARS TOWER, CHICAGO, IL, 60606-6473, US

(21) Appl. No.: 10/911,808

(22) Filed: Aug. 5, 2004

(30) Foreign Application Priority Data
Aug. 6, 2003 (DE) 103 36 070.0

(51) Int. Cl. G06F 17/60

(52) U.S. Cl. 705/72

(57) ABSTRACT

A method and appertaining device provides for secure transaction of payments via a data network, comprising inputting the desire for payment by a purchaser on a device connected to the data network; transmitting the desire for payment from the device to a server computer of a seller via the data network; transmitting an encrypted communication acknowledging the desire for payment from the seller to the device via the data network; a query and input of a password by the user to a checking device connected to the device; unlocking the checking device given a correctly input password or abort of the payment event given an incorrectly input password; displaying the communication on the checking device; authorizing communication by the user or abort of the payment event; transmitting a transaction authorization to the seller via the device; and submitting the transaction authorization by the seller to a business handling the payment.

### BACKGROUND OF THE INVENTION

The invention concerns a method for secure transaction of payments via a data network.

The number of purchases transacted over the Internet has risen sharply in the past years. However, a still larger turnover growth is prevented by the lack of a simple, transparent, anonymized, secure and mobile payment via the Internet. From the view of the customer, it is absolutely necessary that the transaction is secure. This means that it must be ensured that the customer is paying the real seller, and not an imposter.

In addition to this, it is important that the customer only pays exactly the selling price according to the Internet offer of the seller. It must be ensured that no one, not even the seller, has the possibility to debit an amount of money more than the selling price. From the view of the seller, it must be ensured that he has also actually received the money. Moreover, it is necessary that an interference with the transmission during the transaction does not lead to a false accounting entry. Such interferences with the Internet can never be completely eliminated.

In many cases, for data protection reasons, it would be desirable that the seller does not learn the identity of the customer. This viewpoint occurs, for example, with cost-incurring content on the Internet such as electronic newspapers or databanks in which no goods must be shipped to the customer.

Moreover, it is desirable that the buyer can use the method at any time, even while mobile. The method therefore may not require hardware components that the customer can only use at home on his personal computer. So that the method is used by as many people as possible, it must be very simple and be able to be implemented and understood by everyone, without a learning effort being necessary. It must also be possible in a very simple manner for a seller (meaning a payment receiver) to change over to the payment system without incurring large costs.

Methods for the transaction of payments over a data network, in particular the Internet, are already known in which the payment ensues via a credit card. However, this is problematic because the encryption method applied does not protect against a virus-like interception software (e.g., spyware) on the computer, in what are known as “Trojans”. Cases have already been known in which the credit card information has been abused by the seller. In these situations, the customer data was either used by the seller with fraudulent intent or third parties who have attained the credit card information via attacks on databases of the seller.

Many people have a skeptical attitude towards payment by credit card since the payments are not anonymous. Other methods for transaction of payments that, for example, are used in the field of home banking and operate by way of special key cards are not mobile, nor transparent, nor simple.

Other known methods for the transaction of payments, such as the debit method or the shipment of goods on account, can only be implemented nationally and are insecure for the seller. It is known to transact payments via calling an at-cost 0190 or 0900 telephone number. However, this leads to a media break since the device to be operated during the purchasing event must be changed. This method is therefore uncomfortable for users and is error-prone.

### SUMMARY OF THE INVENTION

The invention is therefore based on providing a method for secure transaction of payments via a data network, in particular the Internet that is simple and secure.

This is accomplished by a method for secure transaction of payments via a data network, comprising: inputting a desire for payment by a purchaser on a device connected to the data network; transmitting the desire for payment from the device to a server computer of a seller via the data network; transmitting an encrypted communication acknowledging the desire for payment from the seller to the device via the data network; querying for a password and inputting the password by the purchaser to a checking device connected to the device; unlocking the checking device given a correctly input password or aborting the payment event given an incorrectly input password; displaying information regarding the communication on the checking device; authorizing the communication by the user or aborting the payment event; transmitting a transaction authorization to the seller via the device; and submitting the transaction authorization by the seller to a business handling payment.

This is further accomplished by a checking device for secure transaction of payments via a data network configured to be connected to a device that can be connected with the data network, comprising: a transmitter and receiver configured to communicate between a buyer and a seller; and an approval mechanism configured for approving a communication sent by the seller and designating a selling price and the payment receiver on the checking device in order to initiate a payment.

These aspects are described with reference to the preferred embodiments below.

The method is generally suitable for financial transactions, particularly with Internet purchases.

According to embodiments of the inventive method described below, the payer communicates his payment to the server computer of the payment receiver or seller. This transaction communication is then conveyed from the payment receiver to a business implementing the payment, which transfers the amount to be paid from the account of the purchaser to the account of the payment receiver.

To transact the payment, a checking device is inventively used that can be connected to another device that can be connected with the data network. The checking device can be carried by the user and can, as needed, connect to a device connected with the data network, particularly the Internet.

The central security feature of the checking device is that the purchaser sees displayed on the checking device the amount to be paid and simultaneously recognizes to whom this amount is paid, and approves his agreement with the transaction to the checking device in a manner that cannot be manipulated. The purchaser therewith has 100% security that only the amount approved by him goes to the seller or payment receiver approved by him, even if the device connected to the data network, the internet line, or the corresponding device of the seller happens to be in the hands of hackers via the use of virus software or other illegal methods.

It is appropriate that a device number and a public key of the business implementing the payment are stored in the device. Every checking device is unambiguously identifiable via the device number. The public key is used together with a private key in a cryptography method.

A still greater security can be achieved in an embodiment when an individual key pair is associated with the checking device, where the public key is stored at the business implementing the payment and the private key is stored in the checking device. The private key is appropriately stored in the checking device such that it cannot be read out.

So that the seller/payment receiver can be unambiguously identified, the seller creates a key pair and a business identification identifying him. This identification is presented to the checking device during the payment event.

For security reasons, an embodiment can provide that the public key of the seller and the business identification identifying him are signed by the business implementing the payment. The signature generated in this manner is a check number that is secured by a private key. Via this method, the receiver of the signed text, who simultaneously possesses the public key of the sender, can ensure that the text originates from this specific sender and is unmodified.

It is preferable that the communication sent by the seller contains the name of the seller, the selling price and, if necessary, information about the purchased goods and/or services. In this manner, the payer sees at a glance to which receiver the payment is paid, how large the payment is, and for which goods the payment ensues.

Embodiments of the device connected to the data network can include a computer, a portable computer, such as a notebook or a palmtop, or even a mobile telephone. The data network can be the Internet or a mobile telephone network. Hybrids are also conceivable in which the access to the Internet ensues via a mobile telephone network. Alternatively, the device can also be connected to the Internet via a wireless LAN connection.

The method can be realized particularly simply when the checking device can be plugged into a slot of the device. A USB interface or a serial or parallel interface of the device can preferably be used as a slot.

For security reasons, it is preferable that the communication sent by the seller is checked in the checking device. For this, the identifying business identification and the public key of the seller are verified via the public key stored in the checking device.

In addition to this, the invention also concerns a checking device for secure transaction of payments via a data network, particularly the Internet, that can be connected to a device that can be connected with the data network.

The checking device is inventively fashioned such that a communication sent by the seller and designating the selling price and the payment receiver can be approved on the checking device in order to initiate the payment.

An embodiment of the invention can provide that the checking device comprises a display and an approval button or key. With this button, a communication of the payment receiver shown on the display can be approved by the purchaser such that the payment event is initiated. Furthermore, it can be provided that the checking device comprises an abort button. With this button, the payment event can be aborted by the purchaser in the event that the communication sent by the payment receiver is wrong or in the event that the purchaser wants to stop the payment, and therewith the purchase.

It is preferable that the checking device can be coupled with a personal computer and/or a portable computer and/or a mobile telephone. For this purpose, the checking device can comprise a USB interface and/or a parallel and/or a serial interface, such that it can be easily coupled with the device that can be connected to the data network.

For security reasons, it is preferable that the public key of the business implementing the payment is stored in the device. In this manner, a communication sent by the seller can be checked, such that the purchaser can be absolutely sure that the payment receiver under the given name is registered with the business implementing the payment.

According to a further advantageous embodiment of the invention, it can be provided that an individual key pair is associated with the checking device, whereby the public key is stored at the business implementing the payment and the private key is stored in the checking device. The communication sent by the user or customer to the seller, and thus the approval of the payment, can thereby also be transmitted in an encrypted manner such that third parties do not have the possibility to read and possibly to manipulate this communication and the payment thereby Initiated.

It is advantageous if the private key is stored in the inventive checking device such that it cannot be read out. The private key can, in particular, not be read out via the device to which the checking device is connected, for example, a personal computer. It is thus not possible to illegally attain the private key.

### DESCRIPTION OF THE DRAWINGS

Further advantages and details of the invention are explained using an exemplary embodiment with reference to the following Figures.

FIG. 1 is an isometric view of an exemplary embodiment of an inventive checking device; and

FIG. 2 is a block flow diagram illustrating and embodiment of the inventive method.

### DETAILED DESCRIPTION OF THE PREFERRED EMBODIMENTS

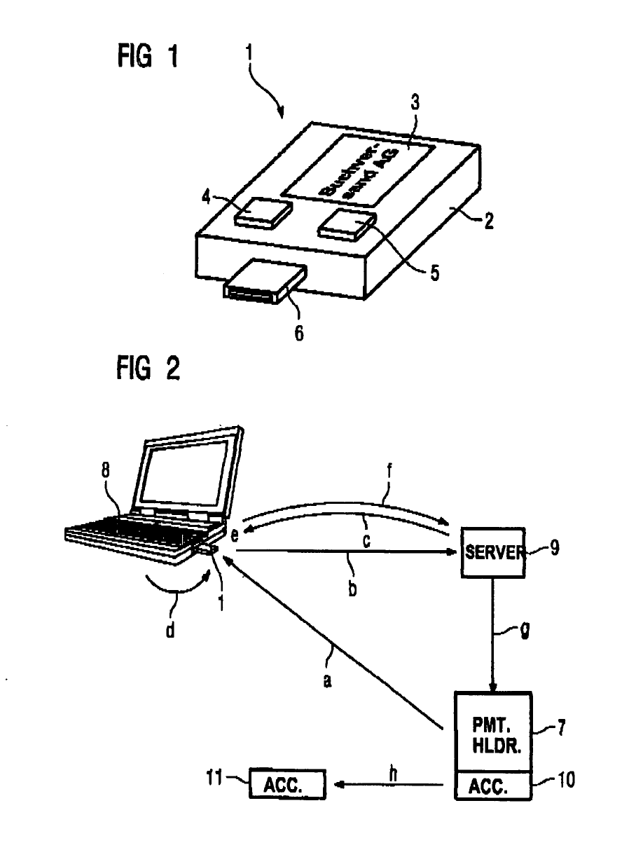

The checking device 1 shown in FIG. 1 possesses approximately the shape of a rectangular solid and primarily comprises a housing 2 on whose front side are arranged a display 3, an approval button 4, and an abort button 5. A USB plug 7 is arranged on a long side of the housing 2 in order to connect the checking device 1 with a device that can be connected with a data network.

Embodiments are also conceivable in which the USB plug 6 is not arranged directly on the housing 2, but rather is connected with the housing 2 via a cable on order to also be able to use the checking device 1 with such devices whose plug connections are more difficult to access. The checking device 1 can be connected via the USB plug 6 with a personal computer or a portable computer, such as a notebook or a handheld computer or palmtop. Alternatively, the checking device 1 can also be connected with a mobile telephone, possibly using an adapter plug.

FIG. 2 shows a flow diagram of the method for secure transaction of payments via the data network. The individual methods steps are designated with lowercase letters.

It is a requirement for the implementation of the method that the business (which is designated as a “payment handler” 7) transacting the payment provides the checking device 1 to a purchaser in method step a. As is shown in FIG. 2, the purchaser has connected the checking device 1 to a notebook 8 that can be connected with the Internet via connections (not shown).

In order to purchase a specific good or service over the Internet, the purchaser selects the corresponding homepage of the seller on the notebook 8, such that he is connected with the server computer 9. The selection of the purchase subject ensues in a conventional manner via clicking on an Internet offer or input of the specific data, such as order number and price. This desire to buy is transmitted to the server computer 9 of the seller in the method step b.

The server computer 9 subsequently sends an encrypted communication to the notebook 8 of the purchaser that acknowledges the desire to buy. Such a communication, which is transmitted in the method step c, has, for example, the content “Buchversand AG receives 100 [symbol] for good X”. This encrypted communication is comprised of multiple parts: the text “100 [symbol] for good X”, a short identification of the seller (which is also designated as the business or visiting card) “Buchversand AG certificate XYZ”, and the public key of the seller, whereby the business card and the public key are mutually signed by the payment handler 7. The term “signature” designates a check number that is generated via a text. This checksum is secured by a private key.

Via this method, a receiver that receives a signed text and possesses the public key of the sender can securely establish that the text originates from the sender and is unmodified. The communication also contains an individual, one-time transaction number, for example “Buchversand. 1234567890”. The entire communication is signed by the seller.

In the next method step d, a password stored in the checking device 1 is queried via special software on the notebook 8. The user must input the correct password on the notebook so that the checking device 1 is unlocked for the transaction. The password, which can also be a number combination such as a PIN, is compared with the password stored in the checking device. This event is controlled by a driver of the checking device 1. It is not possible to read out the password from the checking device 1 in another manner. The driver of the checking device 1 compares the password input on the notebook 8 with the password internally stored in the checking device 1 and unlocks the checking device 1 for the transaction given agreement. Otherwise, the user is required to input the password again, whereby the event may be aborted after multiple false inputs.

After checking the password, the checking device 1 checks the signature of the business card of the seller. The signature of the public key of the seller is likewise checked. Finally, the checking device 1 checks the signature of the entire communication. These checks run in the method step e. Only when all checks are successful is the business card and the amount to be paid shown on the display 3 of the checking device 1. The display “Buchversand receives 100 [symbol] , yes/no?” appears on the display 3 of the checking device 1.

In order to conclude the purchase, the purchaser must press the approval button 4 of the checking device 1. If he wants to abort the event, he presses the abort button 5. After the approval by the customer, an Internal counter in the checking device 1 is increased.

In the method step f, the checking device 1 transmits an encrypted communication to the server computer 9 with the content “100 [symbol] for Buchversand for good X”. For this, the transaction communication must first be assembled by the checking computer 1. This contains the communication text “100 [symbol] for Buchversand for good X, the signed key (publicized by the payment handler 7) of the checking device 1, and the device number (signed by the payment handler 7) of the checking device 1, for example Checking device nr. 1222.7654.8834.4”. This device number specific to the checking device 1 does not have the function of a credit card number and cannot be used alone. The transaction communication also contains the business card of the seller. The transaction communication completed in this manner is secured with the private key of the checking device 1. For the customer, this ensures that only the amount that is authorized can be debited. The seller can not debit the amount multiple times. Only the seller that was shown on the display of the checking device 1 can debit

In the method step g, the seller transmits the transaction communication to the payment handler 7, which executes a transfer (method step h) from the account of the purchaser 10 to the account 11 of the seller.

The money is only debited when the transaction communication is filed with the payment handler 7. The transaction communication is not modifiable, which is ensured by the signature via the key of the checking device 1. The amount and one-time transaction number are stored in the transaction communication such that the transaction communication can only be submitted once to the payment handler.

Furthermore, the business card of the seller is integrated such that the amount can only be credited to the seller and not to a third party that has possibly illegally come into possession of the transaction communication. In order to implement the payment, the customer does not have to cite any personal data such as name and address or other contact information so that he can remain anonymous when he wants. The payment handler 7 identifies the transaction communication exclusively via the device number of the checking device and the public key stored for this at the payment handler.

For the seller, this ensures that he receives the authorized amount. He also has the security that he receives the amount from precisely the customer with whom he wants to transact the payment. Since the associated event is specified in the transaction communication, the packaging and delivery of the purchased goods can ensue particularly simply.

The seller submits the transaction communication to the payment handler 7. The payment handler 7 accepts the communication when he can ensure that the transaction communication comes from one of his checking devices, and when the following requirements are fulfilled: the payment handler 7 accepts the ticket when he receives a business card of a checking device that is signed by the payment handler 7 and when the entire transaction communication is signed by this checking device. It is impossible that a checking device different than the checking device issued by the payment handler fulfills these conditions, since the private key of each checking device is stored in the checking device hardware such that it cannot be read out, meaning only this device can sign a ticket in which its business card is contained.

The seller must thus be able to ensure that the conditions set by the payment handler are ensured: the business card of the checking device must be signed by the payment handler. The seller can check this via the public key of the payment handler. The complete transaction communication must be signed by the checking device and also contain the public key of the checking device. This is signed by the payment handler. The seller can thus check whether the key is authentic. After the check, he can trust this key and can check the entire transaction communication via this key, and then knows for sure that the transaction communication is signed by a valid checking device.

When these criteria of the payment handler are fulfilled, the seller can be sure that he will receive the amount authorized by the customer.

The submission of the transaction communication to the payment handler can, for example, ensue via the Internet. Sellers with low sales volumes can thus also use the method without a large supporting infrastructure. The seller requires no special hardware: the corresponding Internet pages must merely be reprogrammed, which is however, very easy to do.

The method is characterized by a great robustness. Even when interference occurs during the communication, the payment can be transacted. Given an interference with the transmission of the payment requirement of the seller (method step c), this can be repeated arbitrarily often until the correct receipt has been authorized on the checking device via the button press by the purchaser. Given an interference with the transmission of the payment authorization of the purchaser (method step f), this can be transmitted arbitrarily often until it has been transmitted correctly. The successful conclusion of the transaction is acknowledged on the Internet page of the seller. In any case, the unambiguous transaction number of the payment guarantees that the payment occurs only once.

The checking device 1 is protected by the password from misuse, even from theft. In this case, the loss of the checking device can be reported to the payment handler, who provides the sellers with a list of stolen device numbers.

The customer can select special settings on his checking device, for example, that the device only allows purchases up to a fixed amount per month. Analogously, a maximum payment amount for each individual purchase can be established. An authorization for higher amounts can only be applied for directly at the payment handler.

The method can in principle be implemented via any data network. In addition to the transmission over the Internet, the transmission over a mobile radio network is also possible. Likewise, the transmission between the checking device and the device connected with the data network can occur via a wireless interface, for example, according to the Bluetooth standard.

Stationary payment stations can be installed in a simple manner in parking garages, at vending machines, and at other payment locations for small amounts at which customers can implement the payment with their checking device.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

REFERENCE LIST

| | |
|---|---|
| 1 | checking device |
| 2 | housing |
| 3 | display |
| 4 | approval button |
| 5 | abort button |
| 6 | USB plug |
| 7 | payment handler |
| 8 | notebook |
| 9 | server computer |
| 10 | account |
| 11 | account |
| a through h | method steps |

1. A method for secure transaction of payments via a data network, comprising:
inputting a desire for payment by a purchaser on a device connected to the data network;
transmitting the desire for payment from the device to a server computer of a seller via the data network;
transmitting an encrypted communication acknowledging the desire for payment from the seller to the device via the data network;
querying for a password and inputting the password by the purchaser to a checking device connected to the device;
unlocking the checking device given a correctly input password or aborting the payment event given an incorrectly input password;
displaying information regarding the communication on the checking device;
authorizing the communication by the user or aborting the payment event;
transmitting a transaction authorization to the seller via the device; and
submitting the transaction authorization by the seller to a business handling payment.

2. The method according to claim 1, further comprising storing a public key of the business implementing the payment in the checking device.

3. The method according to claim 1, further comprising storing a device number in the checking device.

4. The method according to claim 1, further comprising associating an individual key pair with the checking device, a public key being stored at the business implementing the payment and a private key is stored in the checking device.

5. The method according to claim 4, wherein the private key is stored in the checking device such that it cannot be read out.

6. The method according to claim 1, further comprising creating, by the seller, a key pair and a business identification identifying the seller.

7. The method according to claim 6, further comprising signing a public key of the seller and a business card of the business implementing the payment.

8. The method according to claim 1, wherein communication sent by the seller comprises a name of the seller, at least one of a selling price, information about purchased goods or services, and a transaction number.

9. The method according to claim 1, wherein a computer, a portable computer, or a mobile telephone is used as the device connected to the data network.

10. The method according to claim 1, further comprising plugging the checking device into a slot of the device.

11. The method according to claim 10, wherein a USB interface of a serial or parallel interface is used for the slot.

12. The method according to claim 1, further comprising checking, by the checking device, the communication sent by the seller.

13. The method according to claim 1, further comprising verifying a business card of the seller and its public key utilizing a public key stored in the checking device.

14. The method according to claim 13, further comprising checking the entire communication of the seller with the public key of the seller.

15. The method according to claim 1, wherein the data network is the Internet.

16. A checking device for secure transaction of payments via a data network configured to be connected to a device that can be connected with the data network, comprising:
a transmitter and receiver configured to communicate between a buyer and a seller; and
an approval mechanism configured for approving a communication sent by the seller and designating a selling price and the payment receiver on the checking device in order to initiate a payment.

17. The checking device according to claim 16, further comprising a display configured to display information relating to the communication and an approval button connected with the approval mechanism.

18. The checking device according to claim 16, further comprising an abort button configured to initiate an abort of the communication.

19. The checking device according to claim 16, wherein the device to which the checking device connects is at least one of a personal computer, a portable computer, and a mobile telephone.

20. The checking device according to claim 16, further comprising an interface that is at least one of a USB interface, a parallel interface, and a serial interface to connect with the device that can be connected to the data network.

21. The checking device according to claim 16, comprising a storage area configured to hold a public key of a business of the seller implementing the payment.

22. The checking device according to claim 16, wherein an individual key pair is associated with the checking device, a public key of the key pair being stored at a business of the seller handling the payment, and a private key of the key pair being stored in the checking device.

23. The checking device according to claim 22, wherein the private key is stored in the checking device in a manner preventing it from being read out.

24. The checking device according to claim 16, further comprising a device number.
